(19) United States
(12) Patent Application Publication
(10) Pub. No.: US 2026/0127810 A1
(43) Pub. Date: May 7, 2026

(54) COMPUTER-IMPLEMENTED METHOD FOR UPDATING A REPRESENTATION OF A SPATIAL SCENE

(71) Applicant: Siemens Healthineers AG, Forchheim (DE)

(72) Inventor: Markus-Hermann Koch, Forchheim (DE)

(21) Appl. No.: 19/382,667

(22) Filed: Nov. 7, 2025

(30) Foreign Application Priority Data
Nov. 7, 2024 (DE) 10 2024 210 705.0

(51) Int. Cl. G06T 15/08; G06T 7/11; G06T 7/246; G06T 7/73; G06T 17/20

(52) U.S. Cl. CPC G06T 15/08; G06T 7/11; G06T 7/251; G06T 7/75; G06T 17/20; G06T 2207/20021; G06T 2210/32; G06T 2210/56

(57) ABSTRACT

A method for updating a representation of a spatial scene includes receiving image points, acquiring acquisition points, and assigning acquisition points to corresponding image points based on associated position information. Respective differences are determined by comparing the position information of each acquisition point with the position information of the assigned image point. Acquisition points that have a difference below a tolerance threshold value are excluded from the update. Image points of the representation are grouped into a sub-representation. It is determined whether an acquisition point lies inside a volume generated by a spatial surrounding area and an image sensor, and the sub-representation image point is excluded from the update if the difference of the acquisition point lying in the volume lies above a movement threshold value. Image points of the representation that are not excluded from the update are updated solely based on acquisition points not excluded from the update.

This application claims the benefit of German Patent Application No. DE 10 2024 210 705.0, filed on Nov. 7, 2024, which is hereby incorporated by reference in its entirety.

### BACKGROUND

The present embodiments relate to updating a representation of a spatial scene.

Computer-implemented methods for updating a representation of a spatial scene are known from the prior art. Known solutions for capturing and updating a spatial scene include acquiring point clouds using a suitable camera (e.g., a depth camera, a time-of-flight camera, or a light imaging detection and ranging (LIDAR) camera. Such cameras allow 3D information to be acquired solely for those elements of a spatial scene that are visible to the camera. As this provides it is not possible to acquire a complete 3D scene, such cameras are also referred to as 2.5D cameras. In the analysis of point clouds of a spatial scene that are acquired using 2.5D cameras or LIDAR cameras, surfaces and edges may be recognized and modeled in the form of a 3D mesh model. An acquired scene may be updated continuously to provide that moving objects and changes are recognized (e.g., as part of a collision avoidance system). Collision avoidance systems are employed in robot-assisted X-ray angiography systems, for example.

It is known from the prior art to segment camera-acquired acquisition points of a point cloud. The segmentation leads to the subdivision of the acquisition points into sub-point-clouds. Thus, the acquisition points of a representation are consequently subdivided into subrepresentations. For example, the segmentation may lead to subdivision into sub-point-clouds or subrepresentations that may correspond to elements of the spatial scene, so, for example, to objects or people. It is also known to model such elements, or the associated sub-point-clouds, as a 3D model (e.g., as a 3D mesh model). As a result of such segmentation and modeling, the acquisition points are thus assigned to the segmented sub-point-cloud or the subrepresentation or 3D model (e.g., 3D mesh model) of the associated element of the spatial scene.

### SUMMARY AND DESCRIPTION

The scope of the present invention is defined solely by the appended claims and is not affected to any degree by the statements within this summary.

One problem, for example, in the case of real-time applications (e.g., for collision avoidance), is the considerable computational effort involved in transforming point clouds into 3D mesh models. An additional problem is the limited measurement accuracy of the image sensors used. Both impede the recognition of movements and changes in the scene.

The recognition should be performed as quickly as possible and without latency. Both are integrated into motion planning for avoiding collisions.

The present embodiments are based on the knowledge that static elements of a scene create significant redundancy in the transformation of point clouds into 3D mesh models; for static elements of the scene, which do not move (e.g., walls, tables, equipment), the reprocessing effort for the transformation into a mesh model is not necessary.

The present embodiments may obviate one or more of the drawbacks or limitations in the related art. For example, methods for transforming a point cloud into a 3D mesh model for updating a spatial scene are improved and sped up, accuracy is increased, and the redundancy and inefficiency of such methods are reduced by improving the distinguishing between static and dynamic elements of the scene.

A computer-implemented method for updating a representation of a spatial scene includes: S1) receiving image points of the representation of the spatial scene; S2) acquiring a plurality of acquisition points of the scene using a camera, with each acquisition point of the plurality of acquisition points being assigned position information; S3) assigning acquisition points each to a corresponding image point of the representation based on the associated position information; S4) determining respective differences by comparing the position information of each acquisition point with the position information of the assigned image point; and S5) excluding from the update the acquisition points that have a difference below a tolerance threshold value. The excluding includes: S6) grouping a plurality of image points of the representation into a sub-representation; S7) if the difference lies above the tolerance threshold value for a subset of the sub-representation image points, and below the tolerance threshold value for a further subset of the sub-representation image points, defining a spatial surrounding area for a sub-representation image point of the subset that has a difference above the tolerance threshold value; S8) determining whether at least one acquisition point lies inside a volume generated by the defined spatial surrounding area and the image sensor of the camera; and S9) excluding the sub-representation image point from the update if the difference of the at least one acquisition point lying in the volume lies above a movement threshold value. The computer-implemented method also includes: S10) updating solely the image points of the representation that are not excluded from the update solely based on acquisition points not excluded from the update; and S11) providing the updated representation.

The term scene should be understood in the broad sense here. For example, the term scene may refer to an actual spatial scene that may be captured by the camera or a plurality of cameras. The spatial scene may include, for example, people, objects, floors, and walls of a room, etc. For example, the spatial scene may be a building or a room in a building. For example, the spatial scene may be a radiology or intervention room in which diagnostic or therapeutic apparatuses or an imaging apparatus and patients or medical personnel are located.

The term representation should be understood in the broad sense here. For example, the term representation may refer to a computer-readable description of image data. For example, a representation may be a two-dimensional (2D) representation in which each image point corresponds to a pixel. A representation may also be, for example, a three-dimensional (3D) representation in which each image point corresponds to a voxel. A 3D representation is related to a 2D representation of the same subject by depth information assigned to the image points of the 2D representation. The three dimensions of a 3D representation may correspond to those of a Cartesian coordinate system, for example. The third dimension may also be depth information, for example, that is determined by a 2D camera and assigned to the image points. Such cameras are also referred to as 2.5D cameras because although such cameras may capture a complete 2D depiction, in principle, such cameras do not capture the third dimension in full. The information about the third dimension of an image point (e.g., the depth information) may be determined solely for the pixels of the 2D depiction. Image points that lie one on top of the other from the perspective of the camera, however, occlude or shadow each other. Therefore, the camera may acquire only the occluding image point but not the occluded image point, which is why no complete 3D depiction is produced.

The term camera may be understood in the broad sense here. For example, the camera may be any camera that may capture 2D acquisition points and additionally assign to these depth information or spatial information. For example, the camera may be a standard 2.5D camera, a time-of-flight camera, or a LIDAR camera. The camera includes an image sensor. The camera may also include lenses or mirrors for adjusting the focal length, aperture (diaphragm), and depth of field, which affect the optical properties and the angle of view.

Acquisition points acquired by the camera are assigned to image points of the representation to be updated if the acquisition points appear under the viewing angle of the camera at the same or a similar viewing angle as an image point of the representation. An acquisition point may thus appear either instead of an image point of the representation or in the immediate viewing-angle surrounding area of an image point of the representation.

Each acquisition point is assigned depth information in addition to a viewing angle. If the depth information is additionally used, it may be determined whether an acquisition point is located at the same spatial position or spatially close to an image point of the representation. If an acquisition point appears under the same viewing angle as an image point of the representation, the acquisition point occludes the image point of the representation. If, in this case, the depth information of the acquisition point corresponds to that of the image point, it may be assumed that the acquisition point is an unchanged image point, or rather a static element of the scene. Otherwise, the element of the scene may have moved towards the camera or away from the camera, or the element of the scene may have been occluded by another element.

Comparing position information should be understood in the broad sense here, and may refer, for example, to comparing the position of image points or acquisition points. The position is obtained from the viewing angle at which an acquisition point is acquired by the camera, and from the depth information that the camera detects for the acquisition point. The position information therefore exists initially in the reference coordinate system of the camera. If spatial differences between acquisition points are meant to be determined, then, accordingly, either the differences or the position information is to be transformed into a suitable coordinate system (e.g., a Cartesian coordinate system).

The tolerance threshold value is to be selected to take into account the accuracy of the position information that the camera assigns to the acquisition points. The aim of the tolerance threshold value is to suppress apparent differences in the depth or spatial position of an acquisition point or image point that may be caused by measurement inaccuracies of the camera. This may avoid unnecessary computational effort and may improve the informative value and quality of the update of the image representation.

The method according to the present embodiments achieves better recognition of unchanged, static elements. Apparent alterations, which may be caused, for example, by partial shadowing of such elements by other, moving elements of the scene, are not meant to lead to an unwanted change to the static elements. Acquisition points of a point cloud that may be associated with such apparent changes are therefore not used to update the static elements by a renewed 3D mesh model transformation. Changes to image points of a static element that represent solely an apparent change in the static element are likewise not used for the renewed 3D mesh model transformation of the static element. This selective update process reduces the computing load considerably and improves the efficiency of the system.

The method uses one or more cameras that capture acquisition points and determine their positions in space. The method compares these acquisition points with an existing 3D model of the surrounding area and adapts the 3D model if it is established that no acquisition points are found in the surrounding areas of the vertices. The method takes into account, for example, however, the possibility of shadowing or occluding: if a model-vertex generated from a previous point cloud of a camera is considered, the spatial surrounding area of which no longer contains any acquisition points in the current point cloud of this camera, the method checks in that case whether current acquisition points are in the vicinity of the projection of the vertex towards the camera. If the distance of the vertex to such a current acquisition point is moreover large, then an occlusion by a new object may be assumed instead of a movement of the segmented object. In this case, the vertex is regarded as still being up to date, and the system does not perform a re-segmentation. This saves computing time and avoids unnecessary alterations to the model.

The method is used to improve a digital 3D model of a spatial scene by comparing point clouds acquired by a camera with the scene. The method differs from the prior art in that the method takes into account not just the difference between the acquisition points and the image points but also the spatial relationship between these. The method recognizes whether a plurality of image points that lie close together form a common surface or structure of an element of the scene. If only some, but not all, of these image points show a strong difference from the acquisition points, which may be explained by occlusion of the sight line, then the method assumes that the surface or structure of the element is still valid and does not have to be updated. If the image points have been previously segmented, the method may also check whether acquisition points differ from the previously segmented image components. If the segmentation was modeled previously as a 3D mesh model having vertices, the method may also check whether acquisition points differ from the previously formed vertices. In this case, the method checks each previously formed vertex and expects that its surrounding area (e.g., the size of which is specified by the resolution of, and the distance from, the camera) also contains acquisition points in the current iteration.

In order to ascertain shadowing or an occlusion, the method checks whether there are acquisition points lying within a specified region around the image points affected by differences. This region extends from the camera to the image points in question. The region is in the shape of a cone if the region extends from the camera through a circle or a sphere around the differing image points. If there are such acquisition points, and if also a strong difference from the image points is exhibited above a movement threshold value, then the method assumes that shadowing exists. When there is shadowing, the differing acquisition points occlude the image points that may be associated with a static element of the scene. When shadowing exists, the method does not update the surface or structure of the static element despite differing acquisition points.

If such acquisition points do not exhibit any strong difference, then the possibility exists that the object has moved. In this case, it is sensible to discard the model of the object and to re-segment this region of the acquisition points. An embodiment of a distance limit value for this assumption may be 50 cm, for example. Only if the distance of a new acquisition point to the vertex is sufficiently great (e.g., greater than the limit value of 50 cm) is it assumed that the acquisition point is not attributable to a movement of the segmented object but to shadowing or occlusion by a new object.

A technical advantage of the method is that the method increases the accuracy and stability of the 3D model. The method avoids that small errors or noise in the camera images lead to major updates to the 3D model. The method may better distinguish between true changes in the real scene and false conclusions based on shadowing or measurement inaccuracies.

The updated representation is provided by the method, for instance, to be evaluated in a collision avoidance system, or to be displayed on a screen, for example.

A development of the method provides that a sub-representation is retained unchanged if no sub-representation image point is approved for update.

A development of the method provides that a sub-representation is retained unchanged if at most a limited proportion of the sub-representation image points is approved for update (e.g., a proportion of at most half of the sub-representation image points). This provides a plausible criterion that may be specified easily at any time and checked easily to determine whether a sub-representation shall be retained or discarded.

This may also provide, for example, that a sub-representation is retained if not all the sub-representation image points are confirmed by current acquisition points. If none of the current acquisition points in the spatial region of the sub-representation are meant to be used for the update, the assignment of the previous sub-representation image points to the sub-representation may thus be retained, and there is no need for all the sub-representation image points to undergo a current transformation into the 3D model of the scene.

A development of the method provides that the surrounding area of the sub-representation image point is defined to be circular or spherical.

If the surrounding area of the image point is defined to be circular or spherical, a conical volume results, assuming an isotropic angle of view across the image aperture of the camera. From the perspective of the camera, a spherical surrounding area appears to be circular, while a circular surrounding area appears to be circular only under the additional condition that the axis of the circle is aligned with the camera. All that is important is to define a surrounding area for which a conical volume may be assumed at least approximately, because a cone has a simple-to-describe geometry. The simple geometric description simplifies the calculation and hence reduces the computational effort. As a result, the calculation requires fewer resources and may be performed more quickly.

The cone may be made dependent on the angle of view of the camera (e.g., the cone may taper more quickly for a larger angle of view, and may taper less quickly for a smaller angle of view). The angle of view of a camera depends on the focal length of the camera, or rather on the focal length of the camera lens, and the size of the image sensor of the camera. The shorter the focal length, the larger the angle of view. The larger the image sensor, the larger the angle of view. The larger the angle of view, the larger the segment captured of a scene by the camera. In other words, the angle of view thus gives the angle at which a beam of rays that travel from points of a scene to the camera diverges or converges. If an angle of view is assumed that is constant or isotropic across the image aperture of the camera, a point or a circular or spherical spatial surrounding area is imaged in the camera by a conical beam.

A development of the method provides that the surrounding area is defined such that the surrounding area includes all the sub-representation image points that have a difference lying above the tolerance threshold value.

For example, the surrounding area may be defined such that the outer sub-representation image points in question having differences lying above the tolerance threshold value are connected to each other by lines, which would result in a surrounding area in the form of a polygon or polyhedron. The surrounding area may thereby be defined in a particularly simple and straightforward manner. For example, the surrounding area may also be defined such that a circle or sphere, or an ellipse or ellipsoid, is adapted or fitted such that the sub-representation image points in question are included. The sub-representation image points in question may be tightly enclosed in this case, with the possibility of setting a margin as the upper limit for the distance from outer sub-representation image points.

Defining the surrounding area, for example, as a circle or sphere would be advantageous because this results in a conical volume having the advantages outlined above.

A development of the method provides that the comparing of position information is performed such that a spatial distance is determined as the difference.

For example, when the update of the image representation is meant to relate largely to spatial changes, the distance between acquisition points and image points is an essential criterion. Spatial changes to points are reflected primarily in alterations in the position, which may be captured as a distance. In one embodiment, the essential criterion may be confined to the distance, and any potentially available further information may be ignored. This may avoid additional computational effort, and potential inaccuracies in the potentially available further information cannot impair the result.

A development of the method provides that the tolerance threshold value equals 5 cm to 50 cm (e.g., 15 cm).

A development of the method provides that the movement threshold value equals 35 cm to 65 cm (e.g., 50 cm).

A development of the method provides that the movement threshold value is defined as half the distance from the sub-representation image point to the camera. This makes a plausible assumption for the movement threshold value, and the movement threshold value may be defined easily and quickly for each sub-representation image point.

A development of the method provides that the representation of the spatial scene has the format of a 3D net model.

A 3D net model is a frequently used digital surface model, which may be used to represent a subject or person digitally in 3D. A 3D net model may consist of corner points (e.g., vertices), edges, and faces. The corner points are used as coordinates. The edges connect adjacent corner points. The faces are bounded by the edges and are in the form of polygons. Alternatively, a 3D net model may also be created according to other methods, for example, in order to be able to make the surfaces of the model smoother or more flexible.

Such other models, however, are often more difficult to handle and result in higher computational effort. Using a 3D net model has the advantage that these models are widely established, and it is possible to draw on extensive knowledge and existing applications.

A development of the method provides that in order to obtain a sub-representation, the representation is segmented. The segmentation determines related regions of the representation, with image points that belong to a related region being grouped into a sub-representation.

The segmentation is a known procedure in digital image processing. The segmentation involves determining regions of a pictorial representation that have related content and may represent, for example, individual subjects or people. The grouping of adjacent pixels or voxels belonging to such a region is referred to as segmentation. What is known as semantic segmentation, in which an image is subdivided into segments belonging to specific classes, may be particularly relevant in spatial scenes. In this process, a class (e.g., a person or table) is assigned to each pixel or data point. Using segmentation to obtain a sub-representation has the advantage that segmentations are well known and well understood, and therefore, it is possible to draw on extensive knowledge and existing applications.

### BRIEF DESCRIPTION OF THE DRAWINGS

FIG. 1 shows a spatial scene;

FIG. 2 shows an example representation of the shadow-casting problem;

FIG. 3 shows a method according to an embodiment;

FIG. 4 shows image points when a shadow is cast; and

FIG. 5 shows a circular surrounding area of a shadowed image point and an associated volume.

### DETAILED DESCRIPTION

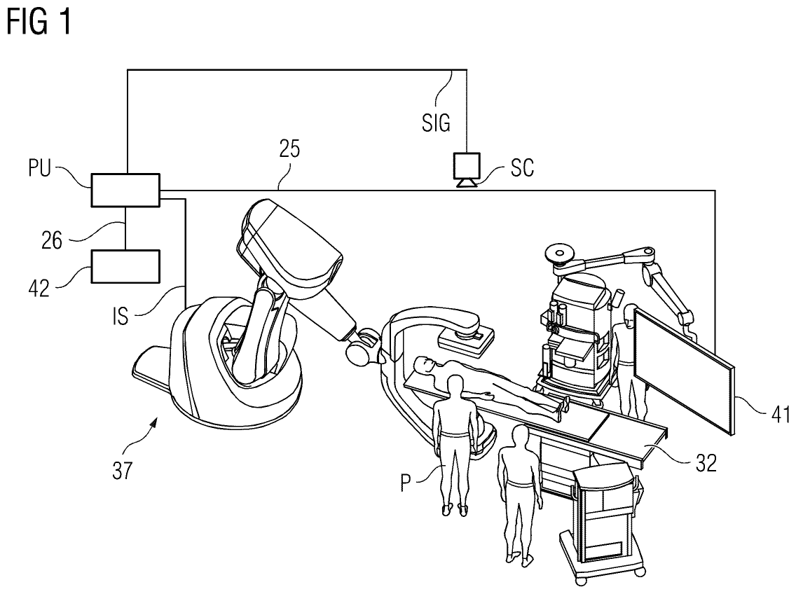

FIG. 1 illustrates a spatial scene schematically by way of example. A 2.5D camera SC is arranged such that the 2.5D camera SC may capture a spatial scene. The spatial scene includes a robot-assisted X-ray facility 37, a patient table 32, and a display 41. On the patient table 32 is a patient, and people P are located in the spatial scene. The 2.5D camera SC is connected to a control device PU via a data connection SIG. The data connection SIG is implemented in conventional technology and may work both wirelessly and on a wired basis.

The control device PU is connected via a data connection S to the X-ray facility 37 and the display 41. The control device PU may be configured to control the X-ray facility 37 and to present X-ray images on the display 41. In addition, the control device PU is connected to a computer unit 42 via a data connection 26. The computer unit 42 is used to evaluate and analyze image information acquired by the camera SC. The computer unit 42 is configured to transform point clouds into a 3D mesh model, and to update the 3D mesh model based on continuously acquired further point clouds.

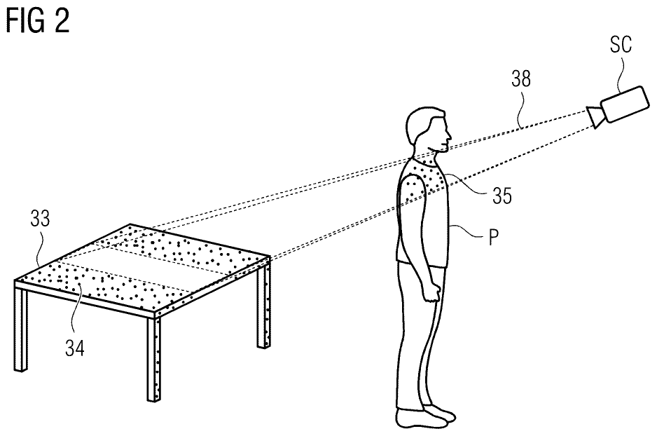

FIG. 2 shows an example illustration of a shadow-casting problem. The spatial scene shown includes a table 33 as a static element. As a result of an earlier segmentation, the table 33 has been recognized as a standalone element of the scene and saved as a sub-representation of the 3D model of the scene. The segmentation has assigned the sub-representation image points 34 to the sub-representation.

Between the table 33 and the camera SC is a person P. The person P occludes part of the image of the table 33 acquired by the camera SC. Thus, the person P is shadowing part of the table 33 from the perspective of the camera SC, and a shadow-casting problem exists. The lines 38 sketch the extent of the cast shadow. The acquisition points 35 within the lines 38 are caused by the person P. The acquisition points 35 are acquired instead of sub-representation image points 34 of the table 33. The acquisition by the camera SC hence no longer represents the sub-representation of the table 33 in full.

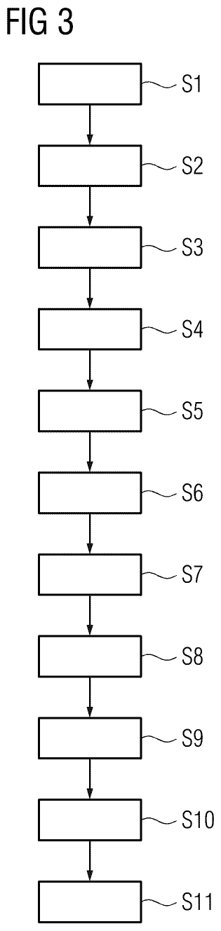

FIG. 3 shows schematically the method according to the present embodiments.

In act S1), image points of the representation of a spatial scene are received.

In act S2), a plurality of new acquisition points are acquired from the scene by a camera. The camera assigns depth information or position information to each acquisition point.

In act S3), for each image point, which, for example, may be assigned to a previous segmentation (e.g., to a table), it is checked whether current acquisition points are to be found in its surrounding area. The size of this surrounding area may be chosen according to factors such as the resolution of the camera and its distance from the image point.

In act S4), respective differences are determined by comparing the position information of each acquisition point with the position information of the assigned image point in each case.

In act S5), acquisition points for which the difference lies below a tolerance threshold value are excluded from the further update. By excluding such acquisition points from the update within a tolerance that may take into account measurement inaccuracies, for example, the transformation of new acquisition points is suppressed, and instead, the former image points are retained.

In act S6), a plurality of image points of the representation are grouped into a sub-representation.

In act S7), it is established whether the determined difference lies above the tolerance threshold value for a subset of the former sub-representation image points, and below the tolerance threshold value for a further subset of the sub-representation image points. If this is the case, a spatial surrounding area is determined for a former sub-representation image point of the subset that has a difference above the tolerance threshold value.

It is thus checked whether the sub-representation, which may be a surface of an object, for example, is still covered uniformly by acquisition points that correspond to the previous image points. In other words, it is checked whether most of the vertices of the sub-representation represented by the earlier image points now have current acquisition points in their surrounding area. If that is the case, the current acquisition points in the vicinity of the sub-representation are dropped, and the sub-representation is retained as “still up to date.” Only after that are the remaining current acquisition points examined and, for example, re-segmented. Hence, for example, a sub-representation of a static table (e.g., a table mesh model) remains for a long time, and computing time is saved by retaining the earlier image points.

The problem may arise here, however, that the coverage of the earlier image points by the currently acquired acquisition points is no longer uniform. For example, the coverage may have a gap or hole of varying size. Thus, in this case, numerous earlier image points exist, in the vicinity of which no current acquisition points are to be found. There are two conceivable reasons for this, amongst others. One may be that the object represented by the sub-representation is no longer present in the scene. Another may be that a new object has moved in front of the previously present object.

Should the object no longer be present in the scene, its sub-representation and the mesh model formed therefrom are to be removed. If a new object should have moved in front of the previously present object, then, at least parts of the sub-representation would now be occluded. Nonetheless, the previous object may still be present in the scene. This is likely, for example, when the previous object was static and unchanged in the scene for a relatively long time and/or when new acquisition points are not spatially close to the object or the sub-representation. In this case, the sub-representation may not be removed at first.

There is now a problem of how to be able to distinguish between the two cases of “object disappeared” and “object occluded.” In this context, the question also arises as to how long an object is to have been present unchanged to be able to count as static and/or how far current acquisition points are to be away from the previous image points of the previous object to be able to count as “not spatially close.” In the subsequent two method acts, it is checked whether one or more current acquisition points are occluding previous image points and are not spatially close to these.

In act S8), it is determined whether at least one current acquisition point lies inside a volume generated by the defined spatial surrounding area and the image sensor of the camera. The extent of the spatial surrounding area may decrease towards the camera according to the angle of view of the camera, or the extent may change according to the ratio in size of the defined spatial surrounding area to the image sensor of the camera.

Thus, it is checked whether for an image point, the surrounding area of which is devoid of new acquisition points, acquisition points are to be found inside the surrounding area of the projection line to the camera. If that is not the case, it is assumed that the image point is obsolete. Otherwise, in the subsequent act S9), it is checked whether these acquisition points associated in this way with the image point have a minimum distance to the image point. If so, shadowing is assumed, and the image point is accepted as still up to date despite the surrounding area being empty of acquisition points. If not, the possibility is to be considered that the sub-representation has changed at this location, and re-segmentation is appropriate.

In the case of a typical 2.5D camera, its resolution or measurement accuracy may be used in setting the dimensions of the spatial surrounding area. Measurement accuracy tolerances may, for example, be of the order of approximately 1.5 mm at a distance of 50 cm, and 5 cm at a distance of 5 m. Thus, the greater the distance of an acquisition point from the camera, the greater the resolution-related blurring. The point is blurred in space according to an occupancy probability density. This blurring is taken into account by the spatial surrounding area and may be described approximately as a sphere or circle. The radius thereof may then be selected according to the measurement accuracy of the camera. In addition, further optical parameters may be taken into account (e.g., field of view, angle of view, fish-eye imaging geometries, and distance to the camera).

A volume is generated between the spatial surrounding area of the image point and the camera eye. If a sphere or circle is selected as the spatial surrounding area, the volume is a cone. If now new acquisition points lie inside the volume, it may be assumed that the image points of the previous sub-representation have been occluded by new acquisition points, or rather, the previously present object has been occluded by a new object. The previous image point, based on which the volume is generated, may consequently be assumed to be still occluded, however. There is obviously the possibility that the previously present object has simply got closer to the camera (e.g., the current acquisition points may still be associated with the sub-representation).

An occlusion or temporary occlusion of the previous object is to be assumed only when the distance of the occluding acquisition points to the assigned occluded image points is large (e.g., in relation to the size of the occluded object). Then, the assumption that the occluding acquisition points may be explained in reality by a deformation of the putatively occluded object appears to be unlikely.

If acquisitions from further cameras are available, these may, if applicable, additionally support the assumption of the object being occluded.

In addition, an occlusion is to be assumed when the extent of the occlusion is increasing, at least initially. An initially increasing extent of the occlusion may correspond to the case of a currently acquired object moving gradually over time in front of the previously present object.

In addition, an occlusion is to be assumed when the current acquisition points in the generated volume are substantially closer to the camera than to the previously present object. In that case, a new object may normally maintain a certain minimum distance to an existing object in order to avoid, when in movement, colliding with the existing object.

In act S9), the sub-representation image point is excluded from the update if the difference of at least one acquisition point lying in the volume (e.g., the conical volume) lies above a movement threshold value. Hence, sub-representation image points that are merely shadowed or occluded are not replaced by acquisition points that result from the shadowing or occlusion.

In act S10), solely former image points of the representation that are not excluded from the update are updated solely based on acquisition points not excluded from the update.

In this case, if too many of the former image points of a sub-representation are to be updated, the previously formed sub-representation is removed from the model. The new acquisition points are retained in its place and used for the segmentation of new objects.

If, conversely, the majority of the former image points of the former sub-representation are excluded from the update and hence are treated as still up to date, instead, all the new acquisition points in the surrounding area of the sub-representation are removed. This simplifies the point cloud formed from the acquisition points. The image in the region of the sub-representation is then retained unchanged.

In act S11), the updated representation is provided to the control device PU. The control device PU may display the updated representation on the display 41, for example, or use the updated representation as part of a calculation for collision avoidance.

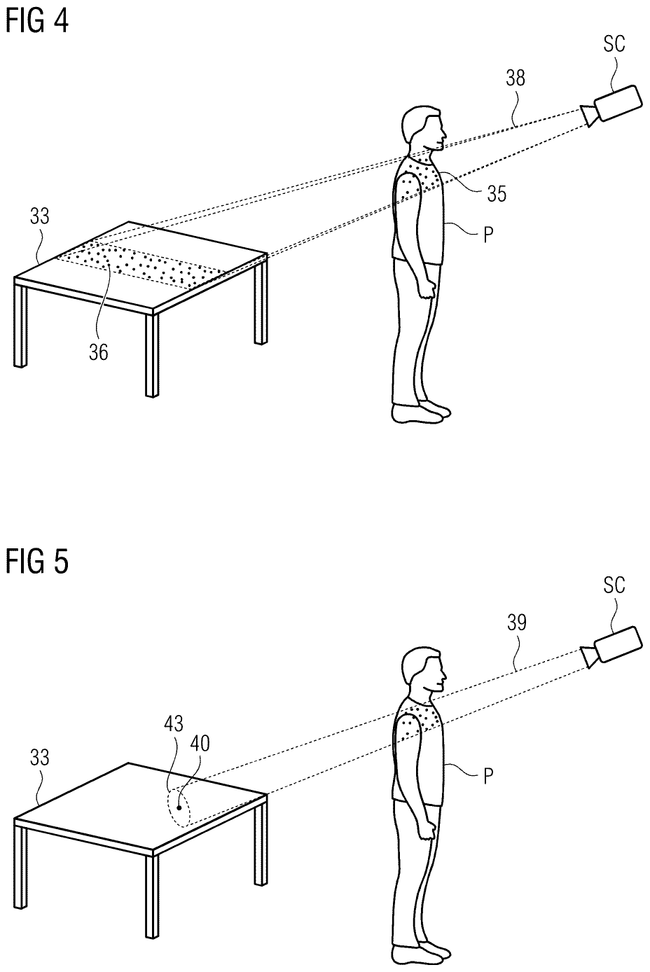

FIG. 4 is used to explain changed and unchanged sub-representation image points of a sub-representation when a shadow is cast. As explained previously with reference to FIG. 2, the acquisition points 35 of the person P occlude previously acquired sub-representation image points 36 of the table 33. In accordance with the method according to the present embodiments, it is established in this situation that some sub-representation image points of the static element table 33 have remained unchanged, whereas other sub-representation image points 36 of the table 33 have changed or are no longer present. The aim of the method is now to establish whether the sub-representation of the table 33 is to be discarded in an update. In this case, all the acquisition points in the spatial region of the sub-representation of the table 33 may have to be analyzed and segmented in order to update the 3D model of the scene. If, conversely, it may be established that the sub-representation of the table 33 is meant to remain, all the acquisition points in the spatial region of the sub-representation of the table 33 may be assumed to be unchanged and need not be analyzed and segmented again and transformed into the 3D model.

FIG. 5 is used to explain with reference to a circular surrounding area of a shadowed static sub-representation image point and a surrounding area defined on the basis thereof, how the method according to the present embodiments determines whether the sub-representation of the table 33 is to be assumed to be unchanged. The aim of the analysis is to determine whether some of the table 33 is occluded by a change in the scene. In the representation, this change is illustrated by the person P. For example, the earlier sub-representation image point 40 of the table 33 is considered, which is not present, or markedly changed, in the current acquisition by the camera SC. A circular or spherical spatial surrounding area 43 is defined around the earlier sub-representation image point 40. Then, the volume between the surrounding area 43 and the camera or the image sensor 39 of the camera is considered. If acquisition points are located inside this volume, the difference in the spatial position of these acquisition points from the earlier sub-representation image point 40 is determined. If the difference in the spatial position of such acquisition points exceeds a movement threshold value, it may be presumed that an element has moved between the table 33 and the camera. In the representation, the person P has moved between the table 33 and the camera. In this case, such acquisition points are not used to update the sub-representation of the table 33. Instead, the current sub-representation image points that belong to the table 33 are assumed to be unchanged and do not undergo analysis and transformation into the 3D model.

In the above description, independent of the grammatical term usage, individuals with male, female, or other gender identities are included within the term.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for updating a representation of a spatial scene, the method being computer-implemented and comprising:
receiving image points of the representation of the spatial scene;
acquiring a plurality of acquisition points of the spatial scene using a camera, wherein each acquisition point of the plurality of acquisition points is assigned position information;
assigning acquisition points each to a corresponding image point of the representation based on the associated position information;
determining respective differences, the determining of the respective differences comprising comparing the position information of each acquisition point of the plurality of acquisition points with the position information of the assigned image point;
excluding the acquisition points of the plurality of acquisition points that have a difference below a tolerance threshold value from the updating, the excluding comprising:
grouping a plurality of the image points of the representation into a sub-representation;
when the difference lies above the tolerance threshold value for a subset of image points of the plurality of image points of the sub-representation, and below the tolerance threshold value for a further subset of image points of the plurality of image points of the sub-representation, defining a spatial surrounding area for a sub-representation image point of the subset that has a difference above the tolerance threshold value;
determining whether at least one acquisition point of the plurality of acquisition points lies inside a volume generated by the defined spatial surrounding area and an image sensor of the camera; and
excluding the sub-representation image point from the updating when the difference of the at least one acquisition point lying inside the volume lies above a movement threshold value;
updating solely the image points of the representation that are not excluded from the updating solely based on acquisition points not excluded from the updating; and
providing the updated representation.

2. The method of claim 1, wherein the sub-representation is retained unchanged if no image point of the plurality of image points of the sub-representation is approved for the updating.

3. The method of claim 1, wherein the sub-representation is retained unchanged when at most a limited proportion of the plurality of image points of the sub-representation is approved for the updating.

4. The method of claim 3, wherein the sub-representation is retained unchanged when a proportion of at most half of the plurality of image points of the sub-representation is approved for the updating.

5. The method of claim 1, wherein the surrounding area of the sub-representation image point is defined to be circular or spherical.

6. The method of claim 1, wherein the surrounding area is defined such that the surrounding area includes all image points of the plurality of image points of the sub-representation that have a difference lying above the tolerance threshold value.

7. The method of claim 1, wherein the comparing of the position information is performed such that a spatial distance is determined as the difference.

8. The method of claim 1, wherein the tolerance threshold value equals 5 cm to 50 cm.

9. The method of claim 8, wherein the tolerance threshold value equals 15 cm.

10. The method of claim 1, wherein the movement threshold value equals 35 cm to 65 cm.

11. The method of claim 10, wherein the movement threshold value equals 50 cm.

12. The method of claim 1, wherein the movement threshold value is defined as half a distance from the sub-representation image point to the camera.

13. The method of claim 1, wherein the representation of the spatial scene has the format of a 3D net model.

14. The method of claim 1, wherein in order to obtain the sub-representation, the representation of the spatial scene is segmented, and
wherein the segmentation determines related regions of the representation of the spatial scene, with image points that belong to a related region being grouped into the sub-representation.

15. A provider unit for providing an updated representation of a spatial scene, the provider unit comprising:
a computing device configured to:
receive image points of the representation of the spatial scene;
acquire a plurality of acquisition points of the spatial scene using a camera, wherein each acquisition point of the plurality of acquisition points is assigned position information;
assign acquisition points each to a corresponding image point of the representation based on the associated position information;
determine respective differences, the determination of the respective differences comprising comparison of the position information of each acquisition point of the plurality of acquisition points with the position information of the assigned image point;
exclude the acquisition points of the plurality of acquisition points that have a difference below a tolerance threshold value from the updating, the computing device being configured to exclude the acquisition points that have the different below the tolerance threshold value from the updating comprising the computing device being configured to;
group a plurality of image points of the representation into a sub-representation;
when the difference lies above the tolerance threshold value for a subset of image points of the plurality of image points of the sub-representation, and below the tolerance threshold value for a further subset of image points of the plurality of image points of the sub-representation, define a spatial surrounding area for a sub-representation image point of the subset that has a difference above the tolerance threshold value;
determine whether at least one acquisition point of the plurality of acquisition points lies inside a volume generated by the defined spatial surrounding area and an image sensor of the camera; and
exclude the sub-representation image point from the updating when the difference of the at least one acquisition point lying inside the volume lies above a movement threshold value;
update solely the image points of the representation that are not excluded from the updating solely based on acquisition points not excluded from the updating; and
provide the updated representation.

16. In a non-transitory computer-readable storage medium that stores instructions executable by one or more processors to update a representation of a spatial scene, the instructions comprising:
receiving image points of the representation of the spatial scene;
acquiring a plurality of acquisition points of the spatial scene using a camera, wherein each acquisition point of the plurality of acquisition points is assigned position information;
assigning acquisition points each to a corresponding image point of the representation based on the associated position information;
determining respective differences, the determining of the respective differences comprising comparing the position information of each acquisition point of the plurality of acquisition points with the position information of the assigned image point;
excluding the acquisition points of the plurality of acquisition points that have a difference below a tolerance threshold value from the updating, the excluding comprising:
grouping a plurality of image points of the representation into a sub-representation;
when the difference lies above the tolerance threshold value for a subset of image points of the plurality of image points of the sub-representation, and below the tolerance threshold value for a further subset of image points of the plurality of image points of the sub-representation, defining a spatial surrounding area for a sub-representation image point of the subset that has a difference above the tolerance threshold value;
determining whether at least one acquisition point of the plurality of acquisition points lies inside a volume generated by the defined spatial surrounding area and an image sensor of the camera; and
excluding the sub-representation image point from the updating when the difference of the at least one acquisition point lying inside the volume lies above a movement threshold value;
updating solely the image points of the representation that are not excluded from the updating solely based on acquisition points not excluded from the updating; and
providing the updated representation.
